(19) United States
(12) Patent Application Publication
(10) Pub. No.: US 2025/0382834 A1
(43) Pub. Date: Dec. 18, 2025

(54) DOOR BLOCKER FOR HOLDING A DOOR IN AN OPEN POSITION

(71) Applicant: Luke Loeber, Davenport, FL (US)

(72) Inventor: Luke Loeber, Davenport, FL (US)

(21) Appl. No.: 19/237,155

(22) Filed: Jun. 13, 2025

Related U.S. Application Data
(60) Provisional application No. 63/661,166, filed on Jun. 18, 2024.

(51) Int. Cl. E05C 17/54; E05C 17/00

(52) U.S. Cl. CPC E05C 17/54; E05C 17/025

(57) ABSTRACT

A door blocking device includes a body having a first surface and a second surface, a nose that includes an attachment aperture, and a bridge the extends between the body and the nose. The bridge, the body and the nose define a receptacle that is adapted to rest on a hinge pin in a blocking position to locate the first surface against one of a door and a jamb of a door assembly, and to locate the second surface against the other of the door and the jamb of the door assembly. The first surface and the second surface in the blocking position are adapted to retain the door in an open position characterized by an angle of greater than 80 degrees with respect to a closed position of the door.

### CROSS-REFERENCE TO RELATED APPLICATION

This application claims priority to and the benefit under 35 U.S.C. § 119(e) of U.S. Provisional Patent Application No. 63/661,166, filed on Jun. 18, 2024, entitled DOOR BLOCKER FOR HOLDING A DOOR IN AN OPEN POSITION, the entire disclosure of which is hereby incorporated herein by reference.

### FIELD OF THE DISCLOSURE

The present disclosure generally relates to doorstops and, more specifically, to a door blocker that is positioned between a door and a jamb and that rests on a hinge pin.

### BACKGROUND OF THE DISCLOSURE

Doorstops are utilized for maintaining a door in an open position. Many doorstops are positioned between the door and the floor for holding the door open. Some doorstops can be placed between a door and a jamb.

### SUMMARY OF THE DISCLOSURE

According to an aspect of the present disclosure, a blocker includes a body and a nose, with a bridge extending between the body and the nose. The body includes a first surface and an opposing second surface that are disposed at an angle. The blocker is configured to be disposed between a door and a jamb, where one of the first surface and the second surface engages an edge of the door and the other of the first surface and the second surface engages an inner surface of the jamb to maintain a door at a particular open position. A bridge includes a recess that rests upon a hinge pin for preventing the blocker from sliding out of a gap between the door and the jamb.

According to another aspect, a door blocking device includes a body having a first surface and a second surface, a nose that includes an attachment aperture, and a bridge the extends between the body and the nose. The bridge, the body and the nose define a receptacle that is adapted to rest on a hinge pin in a blocking position to locate the first surface against one of a door and a jamb of a door assembly, and to locate the second surface against the other of the door and the jamb of the door assembly. The first surface and the second surface in the blocking position are adapted to retain the door in an open position characterized by an angle of greater than approximately 80 degrees with respect to a closed position of the door.

According to another aspect, a door blocking device includes a body having a first surface and a second surface that opposes the first surface, a nose that is attached to the body, and a bridge the extends between the body and the nose to define a retaining region that forms a plurality of hinge receptacles. The retaining region is configured to receive and at least partially encircle a hinge pin of a hinge for a door assembly to define a blocking position. The blocking position is characterized by the first surface resting against a first hinge plate of the hinge and the second surface resting against a second hinge plate of the hinge. The retaining region, the first surface and the second surface in the blocking position are adapted to retain the first hinge plate and the second hinge plate in an open position characterized by an angle of greater than approximately 80 degrees with respect to a closed position of the hinge and a door.

According to another aspect, a door blocking device includes a body having a first surface and a second surface that opposes the first surface, a nose that cooperates with the body to partially define a retaining region, and a bridge the extends between the body and the nose to further define the retaining region. The retaining region is adapted to engage a hinge of a door assembly in a blocking position that corresponds to an open position of the door assembly. In the blocking position, the nose and the body at the retaining region at least partially encircle a hinge pin of the hinge. The bridge is adapted to rest on a surface of the hinge pin. The blocking position is further characterized by the first surface engaging one of a door of the door assembly and a jamb of the door assembly, and the second surface of the body engaging the other of the door and the jamb. The first surface and the second surface are positioned at an angle of greater than approximately 80 degrees to define the open position of the door assembly.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of an aspect of a blocker disposed on a hinge pin for securing a door in an open position;

FIG. 2 is an enlarged perspective view of an aspect of the blocker in a blocking position;

FIG. 3 is a bottom perspective view of an aspect of the blocker shown in the blocking position:

FIG. 4 is a side perspective view of an aspect of the blocker;

FIG. 5 is a bottom perspective view of the blocker of FIG. 4;

FIG. 6 is a side perspective view of an aspect of the blocker shown in a blocking position;

FIG. 7 is a top perspective view of a plurality of exemplary blockers;

FIG. 8 is a bottom perspective view of an aspect of the blocker that incorporates a lighting assembly;

FIG. 9 is a bottom perspective view of the blocker of FIG. 8;

FIG. 10 is a side elevation view of the blocker of FIG. 8;

FIG. 11 is a side elevation view of the blocker of FIG. 8;

FIG. 12 is a side elevation view of the blocker of FIG. 8;

FIG. 13 is a top plan view of the blocker of FIG. 8;

FIG. 14 is a bottom plan view of the blocker of FIG. 8;

FIG. 15 is a cross-sectional view of the blocker of FIG. 13, taken along line XV-XV;

FIG. 16 is an exploded perspective view of the blocker of FIG. 8, shown in a multi-component configuration and with the lighting assembly omitted;

FIG. 17 is a top perspective view of an aspect of the blocker shown in the blocking position;

FIG. 18 is a cross-sectional view of the blocker of FIG. 17, taken along line XVIII-XVIII; and

FIG. 19 is a cross-sectional view of the blocker of FIG. 18 and showing installation of the blocker in a blocking position with respect to a large diameter hinge.

The components in the figures are not necessarily to scale, emphasis instead being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

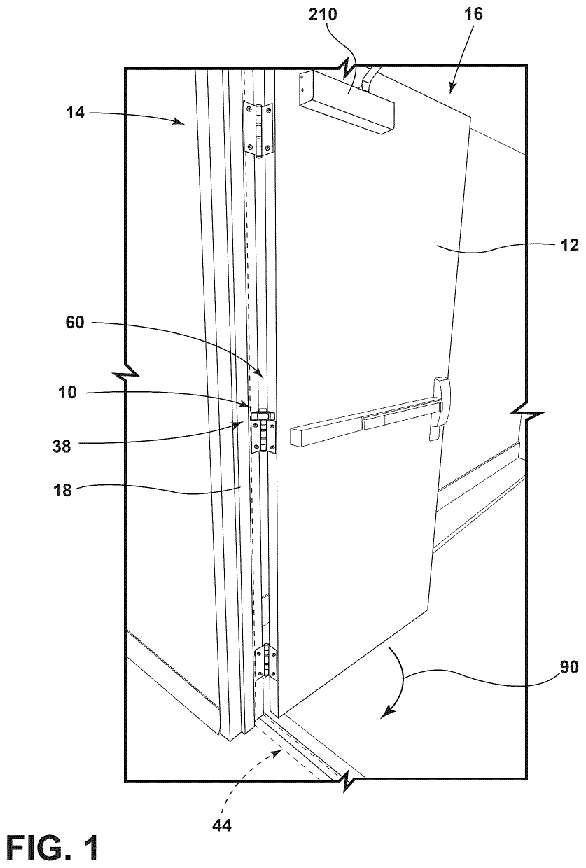

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a blocker for positioning a door at an open position, where the blocker engages a door in a jamb at a particular angle and rests on a hinge pin to prevent the blocker from sliding out of a gap between the door and the jamb. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

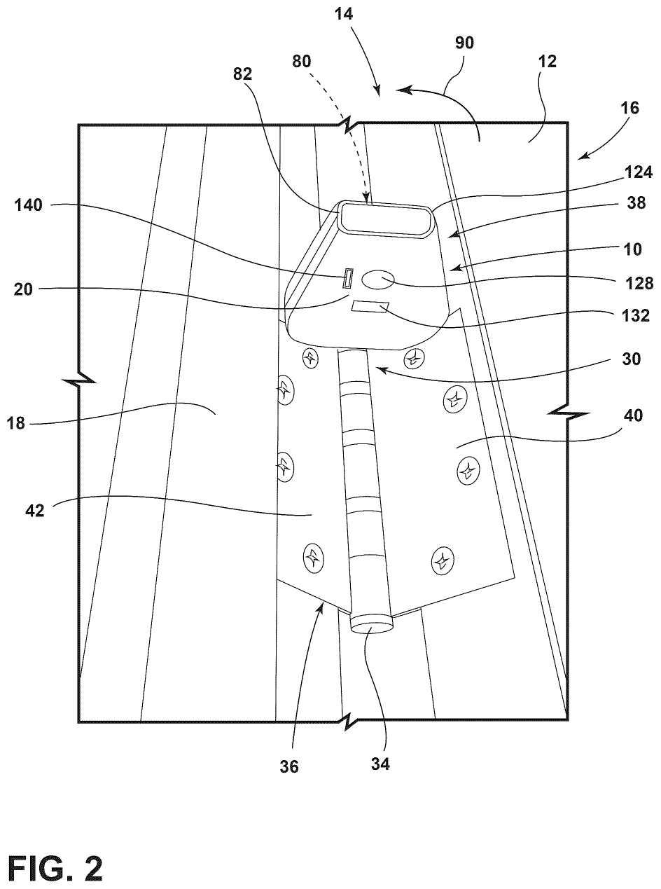

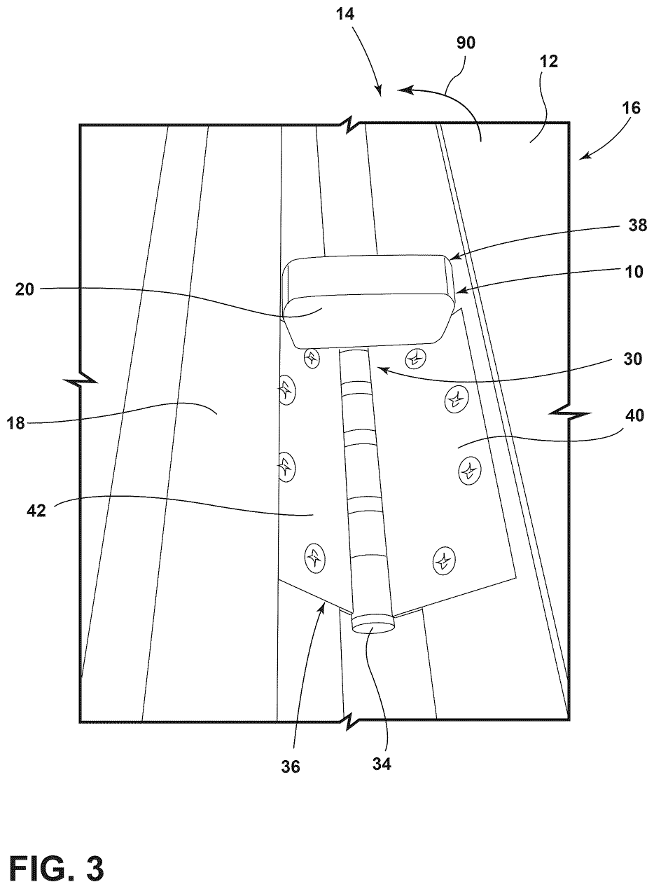

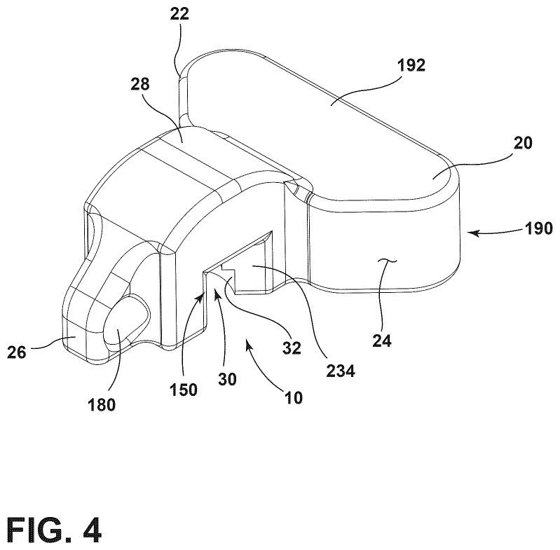

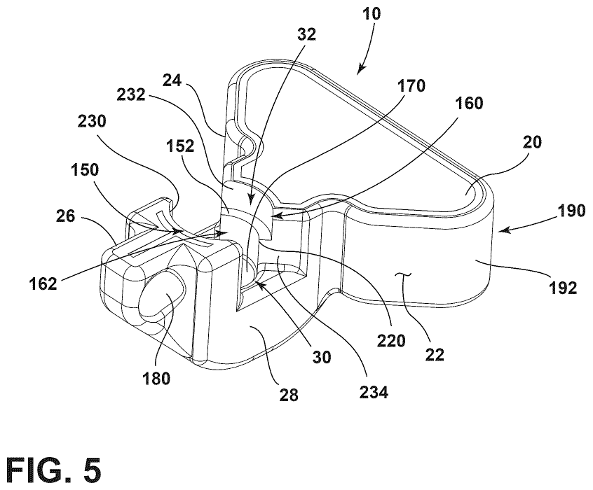

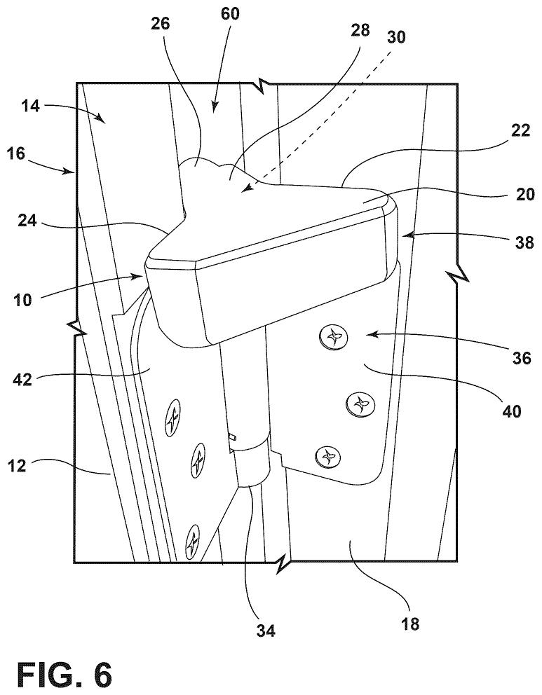

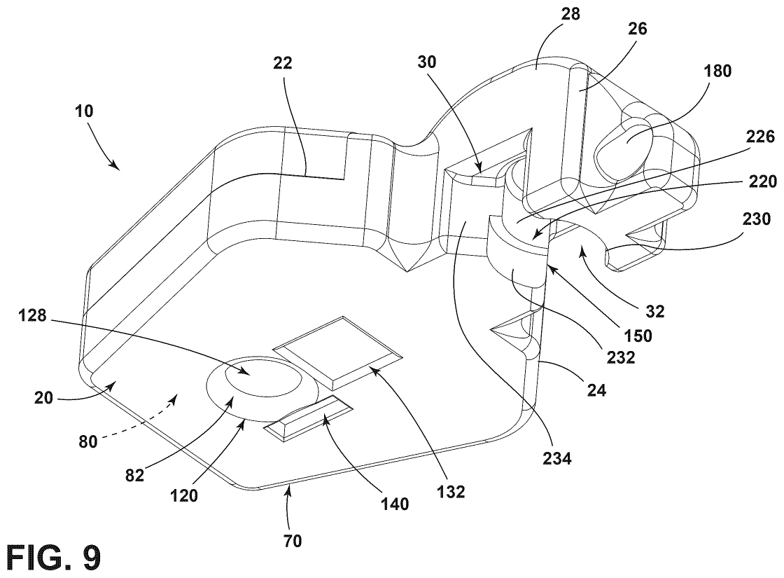

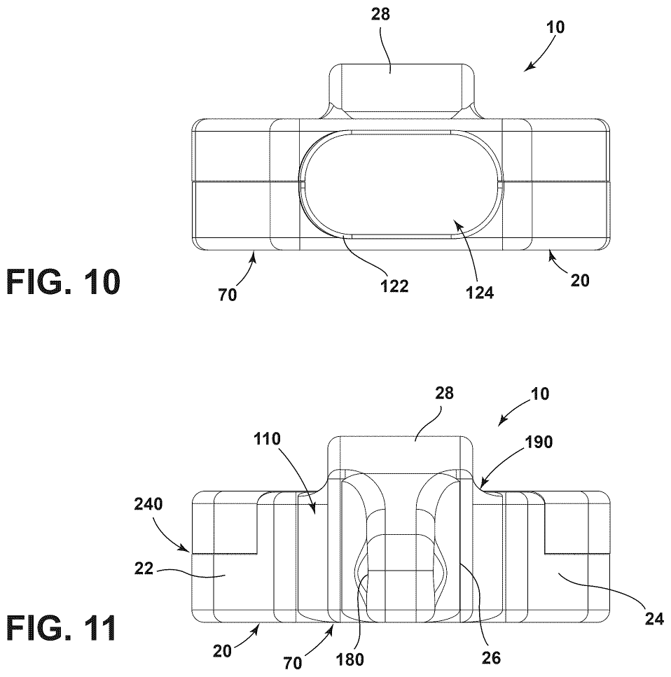

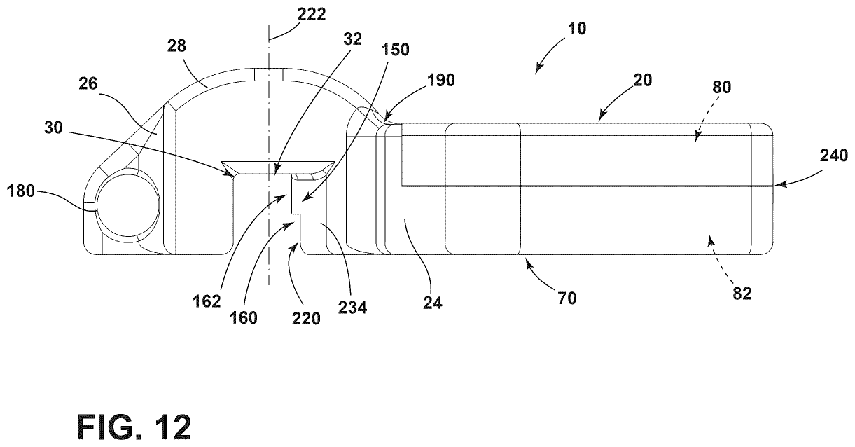

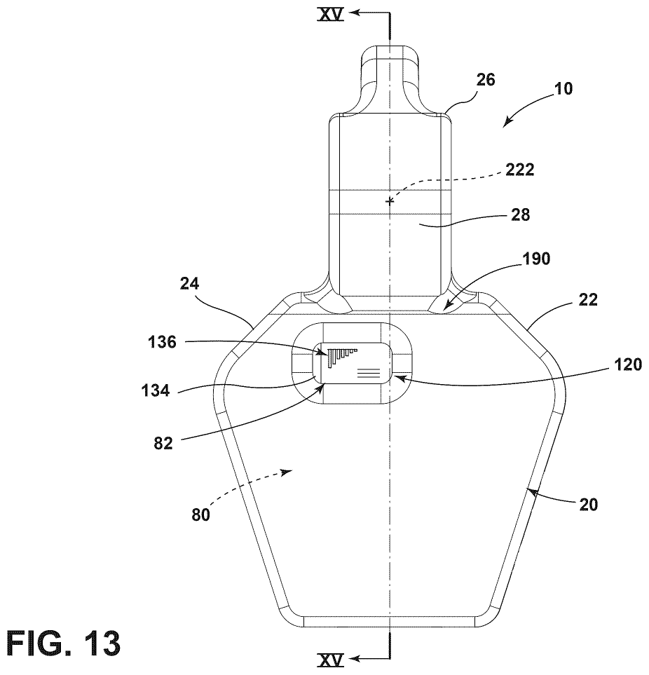

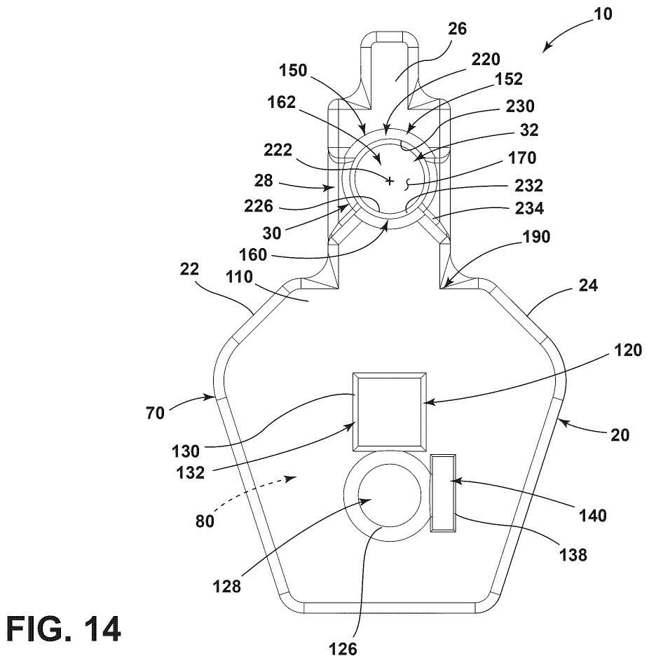

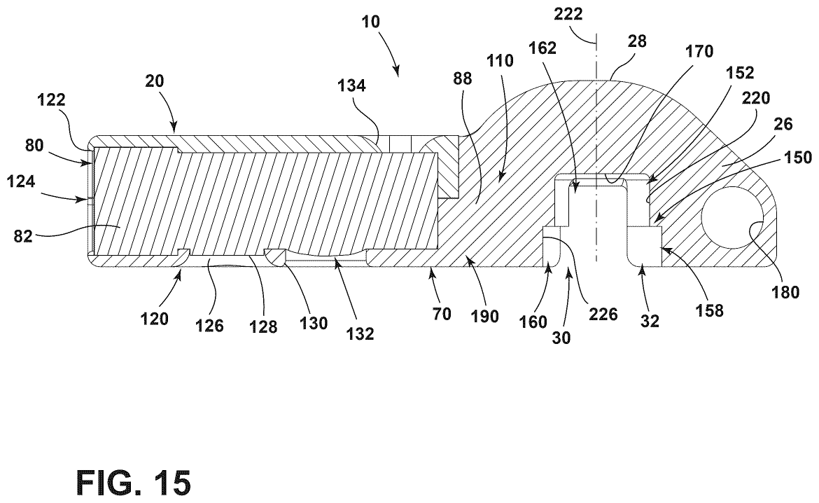

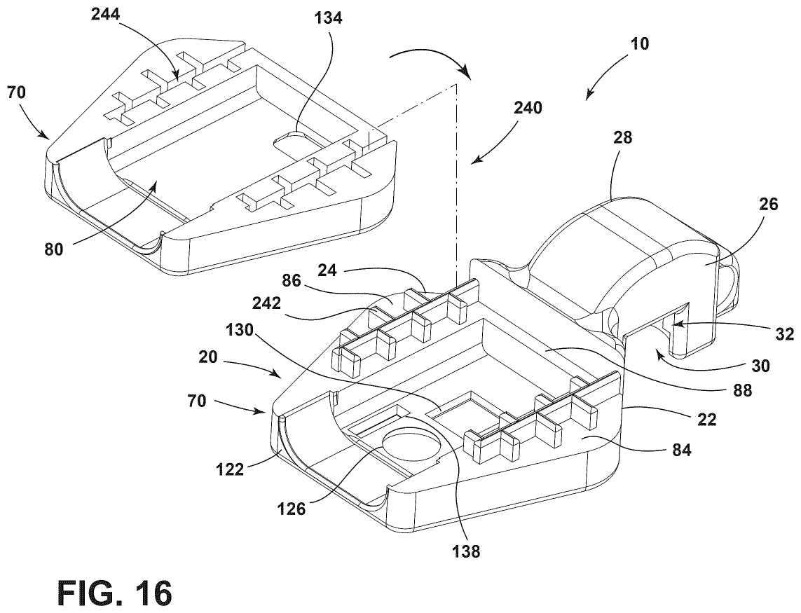

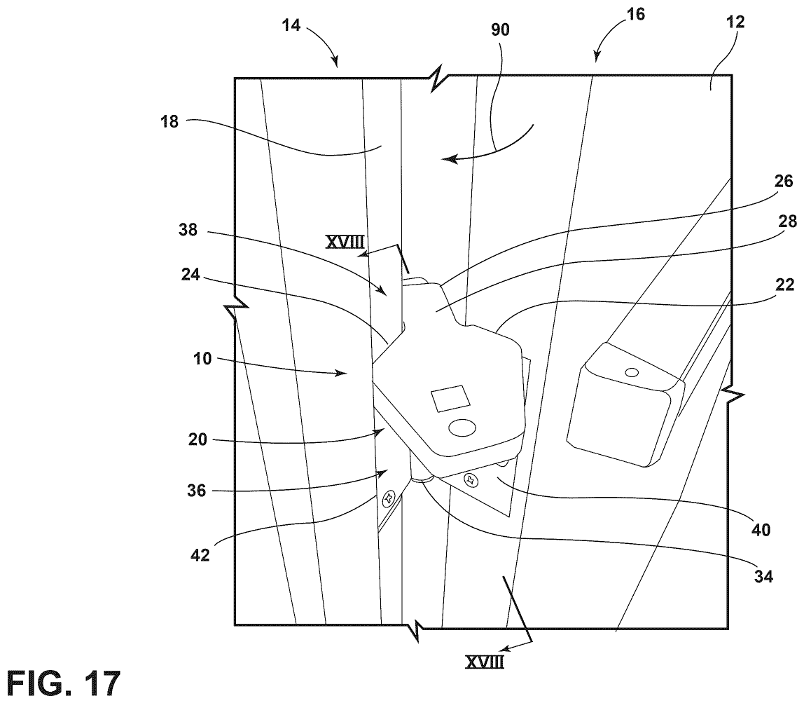

Referring to FIGS. 1-19, reference numeral 10 generally refers to a blocker for holding a door 12 for a door assembly 14 in an open position 16 with respect to a jamb 18 of the door assembly 14. According to the various aspects of the device, the blocker 10 includes a body 20 having a first surface 22 and a second surface 24 that opposes the first surface 22. A nose 26 is attached to the body 20 by a bridge 28 that extends between the body 20 and the nose 26. The nose 26, the body 20, and the bridge 28 cooperate to define a retaining region 30 that forms a plurality of hinge receptacles 32. The retaining region 30 is configured to receive and at least partially encircle a hinge pin 34 of a hinge 36 for the door assembly 14 to define a blocking position 38 of the blocker 10. The blocking position 38 is characterized by the first surface 22 resting against a first hinge plate 40 of the hinge 36 and the second surface 24 resting against a second hinge plate 42 of the hinge 36. The first hinge plate 40 is attached to one of the door 12 and the jamb 18 and the second hinge plate 42 is attached to the other of the door 12 and the jamb 18. In the blocking position 38, the retaining region 30, the first surface 22, and the second surface 24 are adapted to maintain the first hinge plate 40 and the second hinge plate 42 in the open position 16. This open position 16 is characterized by the door 12 being at an angle of greater than approximately 80° with respect to a closed position 44 of the hinge 36 and the door 12 of the door assembly 14.

As exemplified in FIGS. 1-3, 6, and 17-19, in use, the nose 26 of the blocker 10 is positioned within a space 60 defined between the door 12, the jamb 18, and the hinge 36 of the door assembly 14 in the open position 16. The space 60 is typically located above the hinge 36 for the door assembly 14 and between the door 12 and the jamb 18. When the nose 26 is positioned within the space 60, the blocker 10 can be lowered onto the hinge pin 34. In this manner, the retaining region 30 is positioned over the hinge pin 34 of the hinge 36. Accordingly, the retaining region 30 encircles, or at least partially encircles, the hinge pin 34 for securing the blocker 10 to the hinge 36 in the blocking position 38. Engagement of the retaining region 30 with the hinge pin 34 of the hinge 36 provides lateral and rotational support to maintain the blocker 10 in the blocking position 38. In turn, this support that counteracts and limits lateral and rotational movement of the blocker 10 also helps to secure the door 12 in the open position 16. Accordingly, with the blocker 10 in the blocking position 38, where the retaining region 30 encircles the hinge 36, twisting of the blocker 10 within the space 60 and relative to the hinge 36 is prevented. In this manner, the positioning of the blocker 10 to encircle the hinge pin 34 provides a secure interface for maintaining the position of the blocker 10 and also maintaining the position of the door 12 for the door assembly 14 in the open position 16.

For removing the blocker 10 from the hinge 36, the door 12 is moved farther from the closed position 44 to disengage the first surface 22 and the second surface 24 of the blocker 10 from the door 12 and the jamb 18 of the door assembly 14. Once released, the blocker 10 can be lifted off from the hinge pin 34 and the nose 26 can be removed from the space 60 defined between the door 12, the jamb 18, and the hinge 36. Once the blocker 10 is removed, the door 12 can return to the closed position 44.

As described herein, the terms “encircle,” “at least partially encircle,” “partially encircle,” or “substantially encircle” are used to describe the relationship between the retaining region 30 and the hinge pin 34. It should be understood that the terms “encircle,” “at least partially encircle,” “partially encircle,” or “substantially encircle,” as used in relation to the retaining region 30, define a range of encircling configurations. In this manner, the nose 26, the bridge 28, and the body 20 of the blocker 10 define an interface that encircles at least 180° of the hinge pin 34 for the hinge 36. Typically, the retaining region 30 will encircle the hinge pin 34 within a range of from approximately 180° to approximately 300°. It is also contemplated that the retaining region 30 can circle the hinge pin 34 within a range of from approximately 200° to approximately 330°. It is also contemplated that the retaining region 30 can encircle the hinge pin 34 within a range of from approximately 220° to approximately 360°.

According to the various aspects of the device, as exemplified in FIGS. 1-19, the body 20, the nose 26, and the bridge 28 of the blocker 10 can form a single integral piece. This single integral piece can be formed, injection molded, 3D printed, or otherwise manufactured as a single integral piece. It is also contemplated that the blocker 10 can be formed from a plurality of components 70 that are attached together, as exemplified in FIG. 16. Where multiple components 70 are utilized, these components 70 are attached together to form a single unitary member that can be used to position the door 12 in the open position 16, while interfacing with the hinge 36 for the door assembly 14.

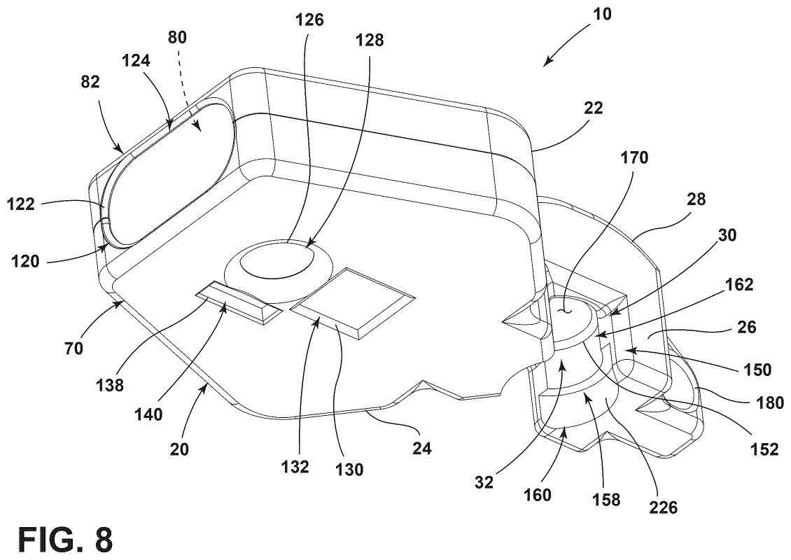

Referring now to FIGS. 8-19, in certain aspects of the device, the body 20 of the blocker 10 includes an interior cavity 80 that houses a lighting assembly 82. In such an aspect of the device, the body 20 includes a first support wall 84 and a second support wall 86 that opposes the first support wall 84. The interior cavity 80 is disposed between the first support wall 84 and the second support wall 86. The interior cavity 80 is also partially defined by a lateral brace 88 that extends between, and is integral with, the first support wall 84 and the second support wall 86. This lateral brace 88 is configured to absorb a closing force 90 that is exerted by the door assembly 14 as the door 12 rotates toward the closed position 44. When the blocker 10 is in the blocking position 38, the lateral brace 88 receives the closing force 90 via the first support wall 84 and the second support wall 86. As described herein, the lateral brace 88 is sufficiently robust to receive and absorb the closing force 90 applied by the door assembly 14 to prevent bending, collapsing, or other deflection of the blocker 10 while in the blocking position 38.

As exemplified in FIG. 16, it is contemplated that the lateral brace 88, the first support wall 84, and the second support wall 86 are formed of a single integral piece within one of the components 70 of a multi-component configuration. Accordingly, closing forces 90 that are transferred between the first support wall 84 and the second support wall 86 between the lateral brace 88 are configured to move directly through a single and continuous structural component 110 of the material that forms the blocker 10. In this manner, the closing forces 90 can transfer through the blocker 10 without transferring through a joint, seam, or other union between separate components 70 of the blocker 10. Also, because of the continuous structure 110 formed by the first support wall 84, the second support wall 86, and the lateral brace 88 that extends therebetween, closing forces 90 can be efficiently transferred through the blocker 10 to retain the door 12 for the door assembly 14 in the open position 16.

Referring again to FIG. 16, typically, where the blocker 10 is in a multi-component configuration, one component 70 can include the nose 26, the bridge 28, and the continuous structure 110 formed by the first support wall 84, the second support wall 86, and the lateral brace 88. The other component 70 can be in the form of a cover that encloses and conceals the lighting assembly 82 within the interior cavity 80. As described herein, and as shown in FIGS. 8-19, the continuous structure 110 formed by the first support wall 84, the second support wall 86, and the lateral brace 88 that extends therebetween directs the closing forces 90 of the door assembly 14 around the interior cavity 80 and around the lighting assembly 82 of the blocker 10.

Referring again to FIGS. 8-19, the body 20 for the blocker 10 includes a plurality of apertures 120 that are used in conjunction with the lighting assembly 82. These apertures 120 can include an end aperture 122 that is used for a utility lighting element 124. This utility lighting element 124 can be used to illuminate an area when the blocker 10 is in the blocking position 38, or can be used as a flashlight. A bottom aperture 126 can be utilized for a down light 128 of the lighting assembly 82. This down light 128 can be utilized for illuminating a floor area around the door assembly 14 when the blocker 10 is in the blocking position 38. In certain aspects of the device, additional apertures 120 of the body 20 can include a power aperture 130 for accessing a power button 132 for the lighting assembly 82 as well as an indicia aperture 134 for viewing various indicia 136 of the lighting assembly 82, such as a power indicator, mode indicator, and other similar indicia. The apertures 120 of the body 20 can also include a recharge aperture 138 for accessing a recharge port 140 of the lighting assembly 82. Using the various apertures 120, the utility lighting element 124 can be permanently contained within the interior cavity 80 while providing for control, recharge, and use of the lighting assembly 82 within the blocker 10.

According to the various aspects of the device, the interior cavity 80 can house additional components 70 such as a laser pointer, one or more auditory alerts, and other similar electrical and/or electromechanical mechanisms that can be disposed within the interior cavity 80 of the blocker 10.

Referring again to FIGS. 1-19, the retaining region 30 that is defined between the body 20, the nose 26, and the bridge 28 of the blocker 10 can include a stepped configuration 150. Within this stepped configuration 150, a plurality of levels 152 can be defined. Each level 152 of the stepped configuration 150 is configured to correspond to a respective diameter 154 of the hinge pin 34. Using this stepped configuration 150, the blocker 10 can be utilized in a range of applications where different sized hinges 36 may be utilized.

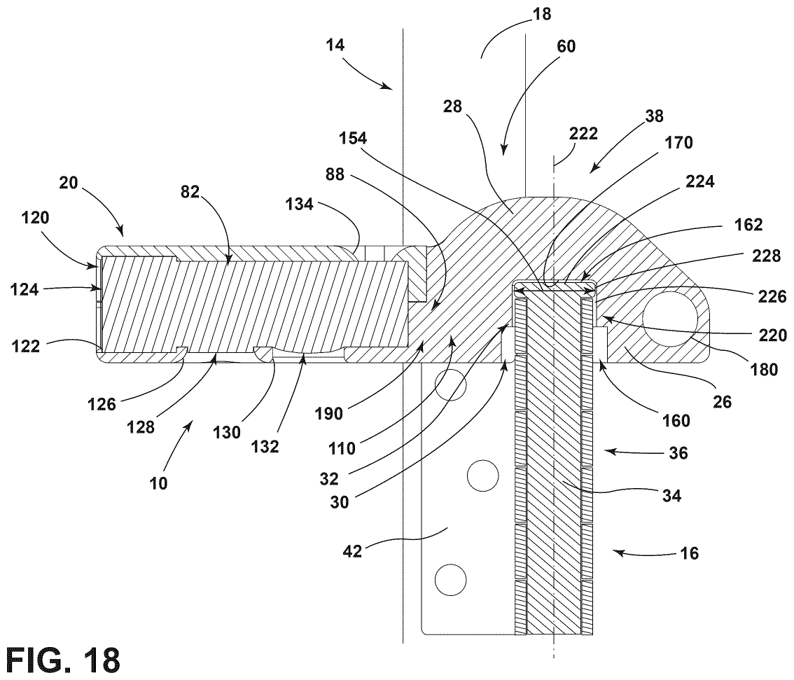

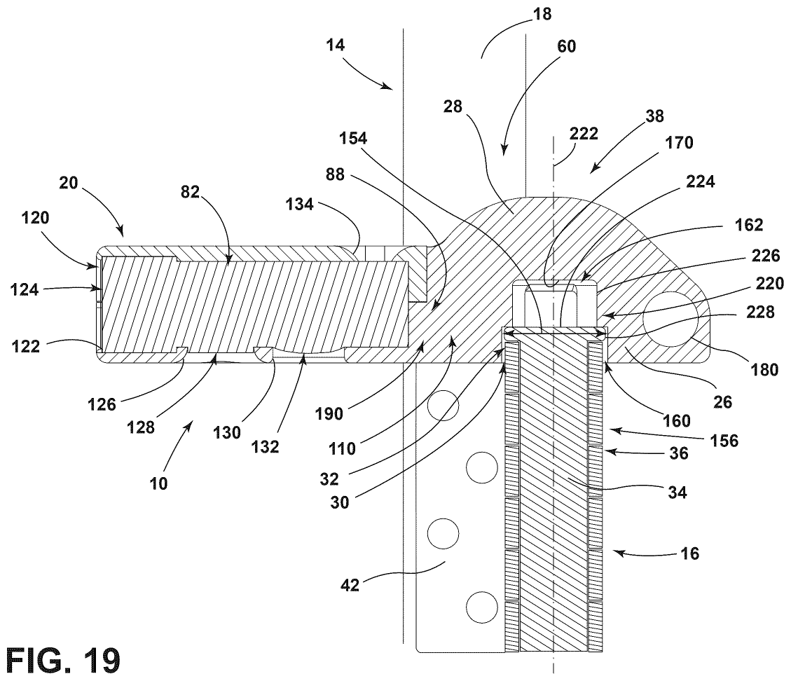

By way of example, and not limitation, a fire-rated door within a facility may have a large hinge 156 that includes a large hinge pin, as shown within FIG. 19. Where the blocker 10 is used, a lower level 158 having a large diameter receptacle 160 is utilized for securing the blocker 10 to the hinge pin 34 for the large hinge 156. Lighter doors and non-fire-rated doors may include smaller hinges that can interface with different levels of the stepped configuration 150, as shown in FIG. 18, indicative of a small diameter receptacle 162.

Each successive level of the stepped configuration 150 that proceeds toward an underside 170 of the bridge 28 can have a smaller diameter to accommodate smaller hinge pins 34. As exemplified in FIGS. 1-19, the retaining region 30 includes two distinct levels within the stepped configuration 150 that form two hinge receptacles 32 in the form of the large diameter receptacle 160 and the small diameter receptacle 162. It is contemplated that the stepped configuration 150 can include additional levels 152 such that more than two distinct receptacles 32 can be defined within the retaining region 30 of the blocker 10.

As exemplified in FIGS. 1-19, each distinct receptacle 32 defined within the retaining region 30 is able to encircle or substantially encircle the corresponding hinge pin 34 using the respective receptacle 32 defined within the retaining region 30 of the blocker 10.

According to the various aspects of the device, as provided in FIGS. 1-19, the blocker 10 can include the body 20, having the first surface 22 and the second surface 24. The nose 26 includes an attachment aperture 180 that can be used for securing a carabiner, keyring, or other similar retaining mechanism for easily storing and accessing the blocker 10. The bridge 28 extends between the body 20 and the nose 26. The bridge 28, the body 20, and the nose 26 define at least one receptacle 32 that is adapted to rest on, and engage, a hinge pin 34 of a hinge 36 in the blocking position 38. While in this blocking position 38, the interaction between the receptacle 32 and the hinge pin 34 locates the first surface 22 against one of the door 12 and the jamb 18 of the door assembly 14 and further locates the second surface 24 against the other of the door 12 and the jamb 18 of the door assembly 14. The first surface 22 and the second surface 24 in the blocking position 38 are adapted to retain the door 12 in the open position 16.

As described herein, the open position 16 of the door 12 is characterized by an angle of greater than approximately 80° with respect to a closed position 44 of the door 12. The angle of the open position 16 is typically similar to the angle between the first surface 22 and the second surface 24 of the body 20. The angle between the first surface 22 and the second surface 24 of the body 20 is typically within a range of from approximately 80° to approximately 100°. It is also contemplated that the angle between the first surface 22 and the second surface 24 can also be within a range of from approximately 85° to approximately 115°. Typically, the angle between the first surface 22 and the second surface 24 will be such that the door 12 is held at an angle of greater than approximately 85° with respect to the jamb 18 of the door assembly 14.

According to the various aspects of the device, as exemplified in FIGS. 1-19, the body 20 of the blocker 10 can include a robust configuration that includes a solid member 190. The solid member 190 can be in the form of a solid body 192. The solid member 190 can also be in the form of the continuous structure 110 that is formed by the first support wall 84, the second support wall 86, and the lateral brace 88 that extends therebetween. As described herein, the lateral brace 88 extends unitarily and continuously between the first support wall 84 and the second support wall 86 to define an uninterrupted robust structural formation that is able to maintain the door 12 in the open position 16 with respect to the jamb 18. In this manner, the body 20 of the blocker 10 is sufficiently robust to hold the door 12 in the open position 16 with respect to the jamb 18 and prevent movement of the door 12 to the closed position 44 until the blocker 10 is intentionally removed. The closing force 90 applied on the door 12 to move the door 12 to the closed position 44 is typically applied by a door closer 210 that automatically biases the door 12 to the closed position 44. The solid body 192 or solid member 190 is sufficiently robust to absorb the force applied by the door closer 210 without deforming, deflecting, or otherwise damaging the blocker 10.

With the door 12 in the open position 16, a user is able to pass through the opening of the door assembly 14 without manually holding the door 12 in the open position 16. In this manner, the user's hands are free to accomplish certain tasks with respect to passing through the doorway of the door assembly 14. Such tasks can include moving luggage or other articles through the doorway, holding the door 12 open for security or egress purposes, combinations thereof, and other similar purposes.

According to the various aspects of the device, the blocker 10 can be made of any one of various materials. These materials can include one or more polymers, carbon fiber, ceramic, metal, combinations thereof, and other similar materials. In certain aspects of the device, the blocker 10 can be made of a heat resistant material that can be utilized by first responders where the blocker 10 may experience high levels of heat. The blocker 10 can also be used by hospitality staff for holding doors 12 in the open position 16. Additionally, use of the lighting assembly 82 within the blocker 10 provides for illuminating the area surrounding the door assembly 14. The lighting assembly 82 can be utilized for indicating that the door 12 is in the open position 16. In this manner, the lighting assembly 82 can utilize various flashing indicia 136, different colored indicia 136, and other similar illuminated indicia 136 for communicating certain information using the lighting assembly 82 of the blocker 10 while in the blocking position 38.

According to the various aspects of the device, as exemplified in FIGS. 1-19, the retaining region 30 of the blocker 10 is defined by a plurality of alignment rings 220 that form the plurality of hinge receptacles 32. The plurality of alignment rings 220 are concentric about a central axis 222 of the retaining region 30 having the stepped configuration 150. In this manner, each of the receptacles 32 is positioned to be centered within the retaining region 30 to position the first surface 22 and the second surface 24 with respect to the door 12 and the jamb 18 to secure the door 12 in the open position 16. As described herein, the alignment rings 220 that form the stepped configuration 150 are typically discontinuous and are divided between the nose 26 and the body 20 of the blocker 10. In this manner, the encircling features of the blocker 10 are apportioned between the nose 26 and the body 20, as described herein, to achieve the encircling function that maintains the blocker 10 in the blocking position 38 and resists the twisting of the blocker 10 within the space 60.

As described herein, placement of the hinge pin 34 within the corresponding receptacle 32 serves to secure the blocker 10 in the blocking position 38 and prevent rotational displacement, lateral displacement, or other similar displacement of the blocker 10 away from the blocking position 38. Accordingly, interaction of the retaining region 30 with the hinge pin 34 serves to securely position the blocker 10 in the blocking position 38 to hold the door 12 in the open position 16. This is the case for doors of varying sizes, weights, thicknesses, and other variations within door assemblies.

According to the various aspects of the device, as exemplified in FIGS. 1-19, the blocker 10 includes the body 20, having the first surface 22 and the second surface 24 that opposes the first surface 22. The nose 26 cooperates with the body 20 to partially define the retaining region 30. The bridge 28 extends between the body 20 and the nose 26 to further define the retaining region 30. The retaining region 30 is adapted to engage the hinge 36 of the door assembly 14 in the blocking position 38 that corresponds to an open position 16 of the door assembly 14. In the blocking position 38, the nose 26 and the body 20 at the retaining region 30 at least partially encircle the hinge pin 34 of the hinge 36. The bridge 28 includes the alignment rings 220 that are adapted to rest on a top surface 224 of the hinge pin 34 to allow the retaining region 30 to at least partially encircle or encircle the hinge pin 34. The alignment rings 220 provide a placement function that aligns a particular hinge pin 34 with the appropriately sized receptacle 32 of the retaining region 30. Where the alignment ring 220 is larger than the hinge pin 34, the hinge pin 34 will pass through that alignment ring 220 and proceed to the next and smaller alignment ring 220. Where the alignment ring 220 is smaller than the hinge pin 34, the alignment ring 220 will rest on the top surface 224 of the hinge pin 34 and a perimeter wall 226 of the alignment ring 220 will encircle an outer edge 228 of the hinge pin 34. This interaction between the retaining region 30 and the hinge 36 secures the blocker 10 in the blocking position 38, as described herein.

The blocking position 38 is further characterized by the first surface 22 engaging one of the door 12 and the jamb 18 of the door assembly 14, and the second surface 24 of the body 20 engaging the other of the door 12 and the jamb 18 of the door assembly 14. As described herein, the first surface 22 and the second surface 24 are positioned at an angle of greater than approximately 80° to define the open position 16 of the door assembly 14, similarly, at an angle of approximately 80° or greater.

Referring again to FIGS. 8-19, the retaining region 30 includes a first arcuate portion 230 that is defined by the nose 26 and a second arcuate portion 232 that is defined by the body 20. These are the arcuate portions configured to at least partially encircle the hinge pin 34 in the blocking position 38. The second arcuate portion 232 is defined by outer walls 234 that are each coplanar or substantially coplanar with the first surface 22 of the body 20 and the second surface 24 of the body 20, respectively. In this manner, the first and second hinge plates 40, 42, which extend from the hinge pin 34 can rest upon the first surface 22, the second surface 24, as well as the opposing outer walls 234 of the second arcuate portion 232 of the body 20. Typically, the first arcuate portion 230 is configured to extend greater than approximately 90° around the hinge pin 34. Collectively, the first arcuate portion 230 and the second arcuate portion 232 of the retaining region 30 substantially encircle the hinge pin 34, as described herein. The retaining region 30, between the first arcuate portion 230 and the second arcuate portion 232, defines cutouts between the nose 26 and the body 20 that allow for the passage of the first hinge plate 40 and the second hinge plate 42 from the retaining region 30 to the door 12 and the jamb 18, respectively. Accordingly, the blocking position 38 of the blocker 10 is defined by a generally mating engagement between the space 60 defined between the jamb 18, the door 12, and the hinge 36 in the open position 16 and the retaining region 30 of the blocker 10. Through this configuration, the retaining region 30 of the blocker 10 rests on, and encircles, the hinge pin 34 while also preventing the door 12 from moving toward the closed position 44 of the door assembly 14. This configuration of the blocker 10 provides for a close engagement between the blocker 10 and the door 12, the jamb 18, and the hinge 36 for the door assembly 14. Through this close configuration, limited movement may be afforded to the door 12 when the blocker 10 is in the blocking position 38. Accordingly, by securing the door 12 in a particular position, inadvertent movement of the door 12 that may provide for dislodging of the blocker 10 with respect to the blocking position 38 may be prevented or limited.

According to various aspects of the device, configurations of the blocker 10 can be defined for certain positions of the door 12. By way of example, and not limitation, a blocker 10 can be configured for holding the door 12 in approximately an 85° angle with respect to a closed position 44 of the door 12. In certain other aspects of the device, the blocker 10 can be utilized for maintaining the door 12 in various angles greater than approximately 85° with respect to a closed position 44 of the door assembly 14.

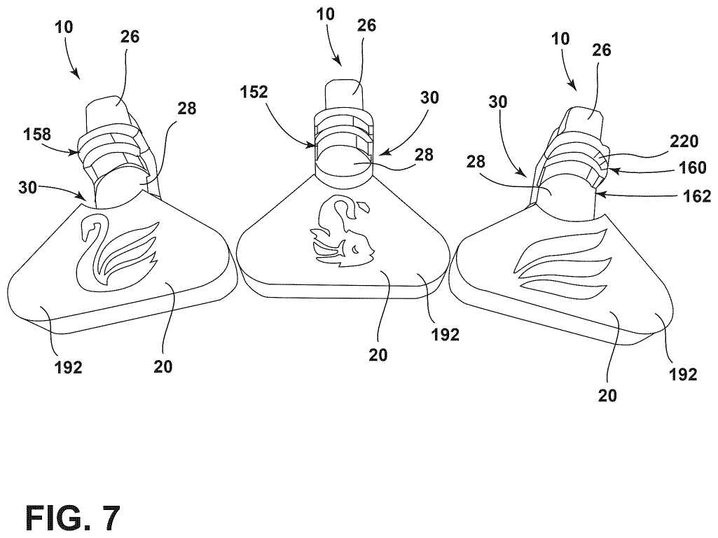

According to the various aspects of the device, as exemplified in FIG. 7, various surfaces of the blocker 10 can be utilized for marketing aspects. These marketing aspects can include logos of certain hotels, resorts, companies, and other facilities, as well as mottos, logos, messaging, and other indicia that can be utilized by these facilities.

Referring now to FIG. 16, in a multi-component configuration of the blocker 10, the blocker 10 can include various mating interfaces 240 that can interact with one another to secure the various components 70 together. By way of example, and not limitation, FIG. 16 exemplifies a mating engagement between various integral tabs 242 that mate with a similarly situated recess 244 within an opposing component 70 of the blocker 10. These components 70 can be adhered, welded, or otherwise attached together to form the unitary configuration of the blocker 10. In certain aspects of the device, this multi-component configuration of the blocker 10 can be utilized for installing the lighting assembly 82 within the interior cavity 80. It is also contemplated that the lighting assembly 82 can be installed within an injection molding operation, 3D printing operation, or other similar forming process where the forming material is printed or otherwise formed around the lighting assembly 82.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A door blocking device comprising:
a body having a first surface and a second surface;
a nose that includes an attachment aperture; and
a bridge the extends between the body and the nose, wherein the bridge, the body and the nose define a receptacle that is adapted to rest on a hinge pin in a blocking position to locate the first surface against one of a door and a jamb of a door assembly, and to locate the second surface against the other of the door and the jamb of the door assembly, and wherein the first surface and the second surface in the blocking position are adapted to retain the door in an open position characterized by an angle of greater than approximately 80 degrees with respect to a closed position of the door.

2. The door blocking device of claim 1, wherein the body, the nose and the bridge form a single integral piece.

3. The door blocking device of claim 1, wherein the body includes an interior cavity that houses a lighting assembly.

4. The door blocking device of claim 3, wherein the body includes a first support wall and a second support wall that opposes the first support wall, and wherein the interior cavity is disposed between the first support wall and the second support wall.

5. The door blocking device of claim 4, wherein the interior cavity is partially defined by a lateral brace that extends between the first support wall and the second support wall.

6. The door blocking device of claim 5, wherein the lateral brace is configured to absorb closing forces exerted by the door rotating toward the closed position.

7. The door blocking device of claim 1, wherein the receptacle in the blocking position is adapted to at least partially encircle the hinge pin.

8. The door blocking device of claim 7, wherein the nose, the body, and the bridge include a stepped configuration of the receptacle, wherein the stepped configuration defines a plurality of levels, and wherein each level of the stepped configuration is configured to correspond to a respective hinge pin diameter.

9. The door blocking device of claim 8, wherein the stepped configuration of the receptacle includes a large diameter receptacle and a small diameter receptacle.

10. A door blocking device comprising:
a body having a first surface and a second surface that opposes the first surface;
a nose that is attached to the body; and
a bridge the extends between the body and the nose to define a retaining region that forms a plurality of hinge receptacles, wherein the retaining region is configured to receive and at least partially encircle a hinge pin of a hinge for a door assembly to define a blocking position, wherein the blocking position is characterized by the first surface resting against a first hinge plate of the hinge and the second surface resting against a second hinge plate of the hinge, and wherein the retaining region, the first surface and the second surface in the blocking position are adapted to retain the first hinge plate and the second hinge plate in an open position characterized by an angle of greater than approximately 80 degrees with respect to a closed position of the hinge and a door.

11. The door blocking device of claim 10, wherein the retaining region is defined by a plurality of alignment rings that form the plurality of hinge receptacles, and wherein the plurality of alignment rings are concentric about a central axis of the retaining region in a stepped configuration.

12. The door blocking device of claim 10, wherein the body, the nose and the bridge form a single integral piece.

13. The door blocking device of claim 10, wherein the body includes an interior cavity that houses a lighting assembly.

14. The door blocking device of claim 13, wherein the body includes a first support wall and a second support wall that opposes the first support wall, wherein the interior cavity is disposed between the first support wall and the second support wall, wherein the interior cavity is partially defined by a lateral brace that extends between the first support wall and the second support wall, and wherein the lateral brace is configured to absorb closing forces exerted by the door rotating toward the closed position.

15. The door blocking device of claim 11, wherein the nose, the body, and the bridge define the stepped configuration of the retaining region, wherein the stepped configuration defines a plurality of levels, and wherein each level of the stepped configuration is configured to correspond to a respective hinge pin diameter.

16. The door blocking device of claim 15, wherein the stepped configuration of the retaining region includes a large diameter receptacle and a small diameter receptacle.

17. A door blocking device comprising:
a body having a first surface and a second surface that opposes the first surface;
a nose that cooperates with the body to partially define a retaining region; and
a bridge the extends between the body and the nose to further define the retaining region, wherein the retaining region is adapted to engage a hinge of a door assembly in a blocking position that corresponds to an open position of the door assembly, wherein in the blocking position, the nose and the body at the retaining region at least partially encircle a hinge pin of the hinge, wherein the bridge is adapted to rest on a surface of the hinge pin, wherein the blocking position is further characterized by the first surface engaging one of a door of the door assembly and a jamb of the door assembly, and the second surface of the body engaging the other of the door and the jamb, and wherein the first surface and the second surface are positioned at an angle of greater than approximately 80 degrees to define the open position of the door assembly.

18. The door blocking device of claim 17, wherein the nose, the body, and the bridge define a plurality of receptacles that are configured to correspond to a plurality of respective hinge pin diameters.

19. The door blocking device of claim 18, wherein the body, the nose and the bridge form a single integral piece, and wherein the body includes an interior cavity that houses a lighting assembly.

20. The door blocking device of claim 19, wherein the body includes a first support wall and a second support wall that opposes the first support wall, wherein the interior cavity is disposed between the first support wall and the second support wall, wherein the interior cavity is partially defined by a lateral brace that extends between the first support wall and the second support wall, and wherein the lateral brace is configured to absorb closing forces exerted by the door rotating toward a closed position.
